(19) United States
(12) Patent Application Publication
(10) Pub. No.: US 2022/0076330 A1
(43) Pub. Date: Mar. 10, 2022

(54) METHOD, APPARATUS, AND COMPUTER READABLE MEDIUM FOR GENERATING A REAL-TIME RISK SCORE ASSOCIATED WITH FINANCING OF AN INVOICE BASED ON REAL-TIME TRANSACTION DATA

(71) Applicant: AGORA INTELLIGENCE, INC., Santa Clara, CA (US)

(72) Inventor: Kevin HOPKINS, Sandy, UT (US)

(21) Appl. No.: 17/469,510

(22) Filed: Sep. 8, 2021

Related U.S. Application Data
(60) Provisional application No. 63/075,513, filed on Sep. 8, 2020.

(51) Int. Cl. G06Q 40/02; G06Q 30/04; G06N 7/00

(52) U.S. Cl. CPC G06Q 40/025; G06N 7/005; G06Q 30/04

(57) ABSTRACT

A method, apparatus, and computer-readable medium for generating a real-time risk score associated with financing of an invoice based on real-time transaction data, including storing a seller profile corresponding to a seller that issues invoices, the seller profile including an invoice transaction history, determining a seller internal probability of default corresponding to a target invoice issued by the seller based on the invoice transaction history associated with the seller, determining a seller overall probability of default based on seller-default variables and dynamic seller-default weights associated with the seller-default variables, and generating a real-time risk score associated with a potential funder financing the target invoice based at least in part on the seller overall probability of default.

### RELATED APPLICATION DATA

This application claims benefit of priority to U.S. Provisional Application No. 63/075,513 filed Sep. 8, 2020, the disclosure of which is hereby incorporated by reference in its entirety.

### BACKGROUND

In the context of invoice financing and this disclosure, the term seller refers to a company that is selling services/products and which obtains financing based upon their outstanding invoices. The term buyer refers to a company named on the outstanding invoices that owes an outstanding balance to the seller. Additionally, the term funder refers to a company or individual that provides funding to the seller utilizing the outstanding invoices and invoice balance as collateral.

There are currently no systems in place that provide a transparent and accurate view of the participants in the invoice financing marketplace and their behavior in that marketplace. Conventional funding/financing systems rely only credit scores and similar metrics which do not provide an accurate or reliable information about whether a particular seller will repay financing or the expected return associated with a particular seller in the relevant marketplace.

Additionally, as multiple parties are involved in invoice financing, the likelihood a particular seller providing a return on financing will also depend on the buyers to whom they have issued invoices. The behavior and records of buyers may vary greatly, not only with respect to other buyers but also with respect to different sellers. For example, a particular buyer may have a much better record with payment of invoices of a large company (i.e., a seller) than payment of invoices of a small proprietor (i.e., a different seller). Current systems do not track buyer information specific to certain sellers or provide any technology infrastructure to track or leverage this information.

Accordingly, improvements are needed in technology systems for tracking, structuring, and store data associated with invoice financing and with risk assessment of relevant parties in invoice financing.

### BRIEF DESCRIPTION OF THE DRAWINGS

FIG. 1 illustrates a flowchart for generating a real-time risk score associated with financing of an invoice based on real-time transaction data according to an exemplary embodiment.

FIG. 2 illustrates an example of the seller profile and invoice transaction history according to an exemplary embodiment.

FIG. 3 illustrates the use of seller invoice transaction history for determination of dynamic weights according to an exemplary embodiment.

FIG. 4 illustrates a flowchart for generating an invoice risk score (projected funder return) according to an exemplary embodiment.

FIG. 5 illustrates an example of a real-time risk score for a company, including different components of the score, according to an exemplary embodiment.

FIGS. 6A-6D illustrate the inputs to the various metrics and scores utilized by the present system in generating the projected annualized ROI and a flowchart for generating the projected annualized ROI according to an exemplary embodiment.

FIGS. 7A-7C illustrate interfaces for viewing invoices and baskets of invoices and bidding on invoices, along with scores corresponding to buyers, sellers, and overall risk, according to an exemplary embodiment.

FIG. 8 illustrates heats maps of the supply chain, industry, or location that summarizes all of the risk scores in a view that allows users see real-time risk per segment according to an exemplary embodiment

FIGS. 9A-9C illustrate tables with raw inputs, model inputs & computation, and risk factors according to an exemplary embodiment.

FIG. 10 illustrates the components of the specialized computing environment 1000 configured to perform the specialized processes described herein.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate also comprise a portion of the invention. However, because such elements do not facilitate a better understanding of the invention, a description of such elements is not provided herein.

Applicant has discovered a method, apparatus, and computer-readable medium for generating a real-time risk score associated with financing of an invoice based on real-time transaction data.

The present system allows for a determination of a probability of default for a seller or buyer that utilizes dynamic and shifting weighting of internal metrics and external metrics, whereby the balance of weighting to internal and external metrics shifts as a function of the quantity of transaction data stored on the system for the seller and its associated buyers. Current financial risk and probability of default measures rely upon external metrics such as those described earlier in this disclosure, which are divorced from the context under which a financing decision is being made on a particular platform. In particular, the most pertinent data for assessing risk is the data that pertains to the same type of transactions, on the same platform. For this reason, internal metrics are likely to have a higher reliability.

In the present system, when the number of transactions (repayment events) are low, the weighting is shifted to external metrics, which are relied upon largely as a proxy for the more relevant internal metrics that would likely have a higher reliability in estimating a probability of default. However, as the quantity of internal transactions increases, the reliability of the internal metrics increases as well, and the dynamic weighting shifts the weight so that internal metrics are given greater weighting than external metrics. This dynamic shifting weighting allows for accurate assessment of risk at all stages of experience and history, whether a seller is new to the platform or a more experienced member of the exchange. The system can actively monitor a quantity, quality, or other metric relating to transactions conducted on the network or stored in a database for a particular seller or buyer, and then dynamically shift weighting based on the detection of transactions or transaction metrics beyond a predetermined threshold.

The present system also enables more granular and accurate assessment of probability of default and other risk metrics through the use of buyer data that is bound to buyer-seller pairings. In other words, internal transaction data and metrics for buyers are not divorced from the sellers to which they owe payment. Instead buyer metrics and transaction data records are linked to the data for specific sellers. This data linkage allows for more accurate assessment of buyer level risk due to default on invoices, since the behavior and data for a buyer may differ among different sellers. For example, buyer A may have a very good track record of timely payment to seller B on seller B's invoices while at the same time having a poor record of payment to seller C on seller C's invoices. This difference only becomes observable in the data set when the transaction data for buyer A is stored in a data structure which references or links to the specific seller for each transaction.

The present system utilizes and ultimately emphasizes metrics derived from internal real-time network transaction data to thereby provide greater visibility into the risk metrics for all parties to an invoice financing transaction and greater accuracy in the risk and probability of default assessment. The linked buyer-seller data structures, transaction data sets, and associated metrics also provide a level of transparency and accuracy in risk measurement that would not be possible without the specific linked records and real-time transaction data.

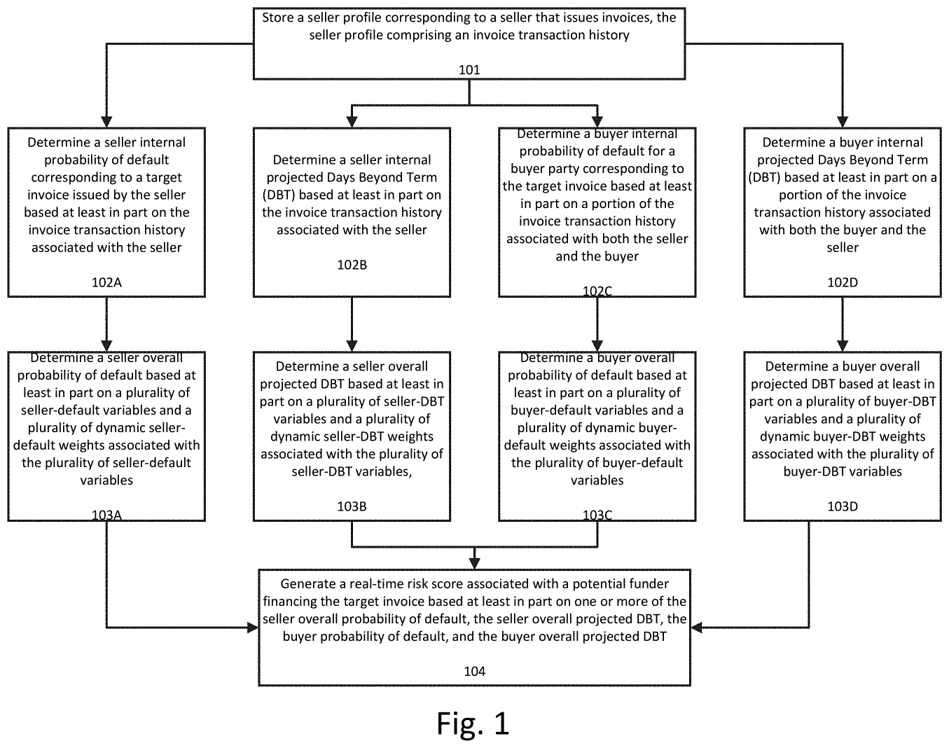

FIG. 1 illustrates a flowchart for generating a real-time risk score associated with financing of an invoice based on real-time transaction data according to an exemplary embodiment.

At step 101 a seller profile corresponding to a seller that issues invoices is stored, the seller profile comprising an invoice transaction history, each invoice in the invoice transaction history being associated with a buyer responsible for payment of the invoice. The seller profile can be stored in multiple different formats. For example, the seller profile can be part of a seller database storing information about all sellers or can be part of a large transaction database. For example, a transaction database can store seller information/names/identifiers in a particular column and each seller profile can include all rows having a particular seller. Many variations are possible.

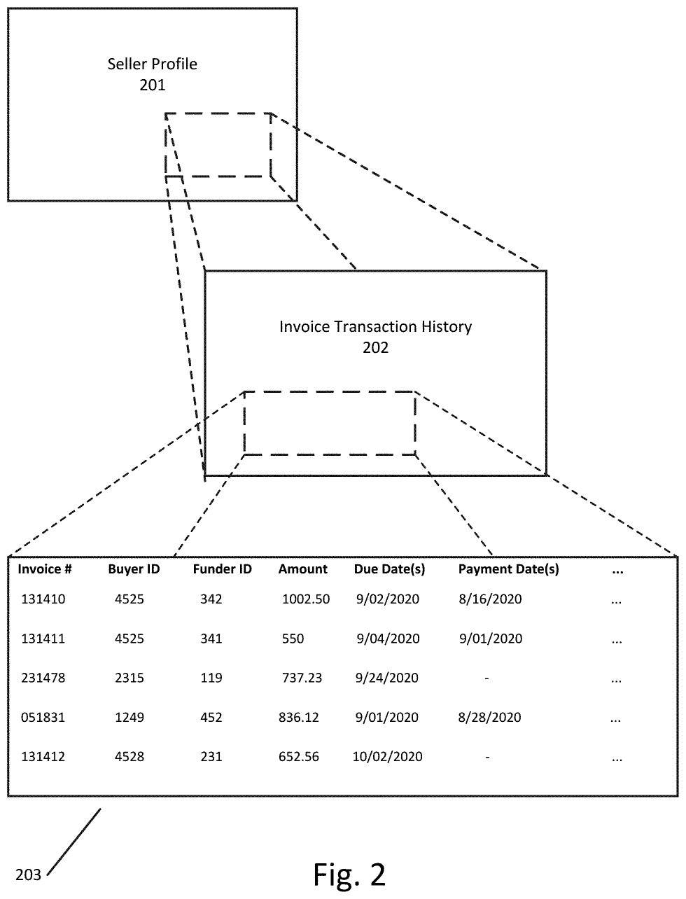

FIG. 2 illustrates an example of the seller profile and invoice transaction history according to an exemplary embodiment. As shown in FIG. 2, seller profile 201 includes invoice transaction history 202. Box 203 illustrates an example of a portion of the invoice transaction history. The transaction history can include, for example, invoice numbers/identifiers, buyer identifiers associated with invoices, and invoice amounts. The transaction history also includes funder information associated with particular invoices, such as the identifier or name of a funder that previously provided funding pertaining to a particular invoice. The transaction history can include one or more due dates, such as the due date for the invoice amount, the due date of repayment of financing, etc. The transaction history can also include payment dates, such as the date of payment of the invoice by the buyer, the date of repayment of financing by the seller, etc. The transaction history can include additional information not shown in FIG. 2, such as invoice terms, conditions, invoice issue date, or any other pertinent information for the invoice, the buyer, the seller, or the funder.

The transaction history will always record the following transactions (including their amounts, dates, timing, and parties):

Payment of an invoice by the Buyer to the Seller

Non-payment of an invoice by the Buyer to the Seller

Repayment of invoice-funding by the Seller to the Funder

Non-repayment of invoice-funding by the Seller to the Funder

Each new Buyer-Seller transaction (or non-transaction) and each new Seller-Funder transaction thereafter will be added to the various measures on an incremental basis until internal measurements and activities dominate the risk score measures, as described in what follows.

Returning to FIG. 1, at step 102A a seller internal probability of default corresponding to a target invoice issued by the seller is determined based at least in part on the invoice transaction history associated with the seller.

The Seller's Internal Probability of Default is determined based on the invoice transaction history of the seller and, in an exemplary embodiment, can be given by the equation:

IPD_{S}=[(A₁*IPS₁)+(A₂*IPS₂)+ . . . +(A_{N}*IPS_{N})]/[A₁+A₂+ . . . +A_{N}]

where:

Aᵢ=the amount of invoice funding i

IPSᵢ=the internal payment status for invoice-funding i, that is, whether the invoice-funding amount was repaid (IPSᵢ=0) or unrepaid (IPSᵢ=1), as described above, within 90 days of its due date, for all invoice-funding repayments over the previous two years. Of course, other periods of time can be utilized.

Of course, other formulations can be utilized which also leverage the invoice transaction history associated with the seller to determine the seller internal probability of default.

At step 103A a seller overall probability of default is determined based at least in part on a plurality of seller-default variables and a plurality of dynamic seller-default weights associated with the plurality of seller-default variables. As discussed below, the plurality of seller-default variables can include a seller integrity score, one or more external probability of default scores associated with the seller, and the seller internal probability of default.

In an exemplary embodiment, the seller overall probability of default (PDₛ) can be determined by the equation:

PD_{S}=CIS_{S}*[(aⱼ*AVERAGE(DBDS_{S},CPDS_{S},IPHDS_{S}))+(bⱼ*IPD_{S})]

As shown above, the PD value is determined based at least in part on a plurality of seller-default variables, including CIS, DBDS, CPD, IPHDS, IPD (internal probability of default, discussed above) and a plurality of dynamic seller-default weights aⱼ and bⱼ. Each of these are explained below in greater detail.

CIS is the company integrity score. Company Integrity Scores (CISs) measure the likelihood that the company in question is legitimate, is operating in good faith, and raises no “red flags.” Assessing a company's CIS involves automated inspection of:

The registrant's identity and liveness verification;

Assessment of whether registrant is a real or synthetic person;

The company's KYB (Know Your Business) score;

The company's AML (Anti-Money Laundering) score;

The KYC (Know Your Customer) score for the individual and the company's beneficial owners; and

In certain cases, individual credit checks for beneficial owners.

The above-mentioned CIS-related metrics can be assessed in a variety of ways, such as identity verification measures, review of registration documentation, checks with public systems tracking company information, etc.

The overall probability of default (PD) determination also utilizes an average of several secondary probability of default scores. These include the Dun & Bradstreet (D&B) Delinquency Score (DBDS), the Crowdz Probability of Default Score (CPDS) developed by Crowdz, and the Seller's Invoice-Payment History Default Score (IPHDS), which is based on data extracted from the Seller's accounting system. For example, all invoiced Seller payments and non-payments to its suppliers or other creditors for the past two years can be utilized to determine IPHDS. Of course, other periods of time can be utilized.

The coefficients aⱼ and bⱼ are dynamic seller-default weights and are regressed as a function of the number of repayment events over the past two years. Of course, other periods of time can be utilized. Until such a regression equation can be estimated, we can define:

aⱼ=0.3+[(0.7*MAX(20−j,0))/20] and

bⱼ=0.7*[MIN(20,j)/20]

For instance, if j=10 (that is, if 10 transactions have been completed in the past two years), then:

$$\begin{matrix}{a}_{j} = 0.3 + [ ( 0.7 * MAX ( 20 - 10 , 0 ) ) / 20 ] \\ = 0.3 + [ ( 0.7 * MAX ( 10 , 0 ) ) / 20 ] \\ = 0.3 + [ ( 0.7 * 10 ) / 20 ] = 0.3 + [ 7 / 20 ] = 0.3 + 0.35 = 0.65\end{matrix}$$

$$\begin{matrix}{b}_{j} = 0.7 * [ MI N ( 20 , 10 ) / 20 ] \\ = 0.7 * [ 10 / 20 ] = 0.7 * 0.5 = 0.35\end{matrix}$$

As a result:

aⱼ+bⱼ=0.65+0.35=1.0

The dynamic weight parameters assign greater weight to the internal, repayment-focused metric and lesser weight to the external metrics as the number of repayment events, j, grows larger.

As shown in the equation above, the plurality of dynamic seller-default weights comprise a first dynamic weight associated with the seller internal probability of default and a second dynamic weight associated with the one or more secondary probability of default scores. Since the value of the first dynamic weight increases relative to a value of the second dynamic weight as the quantity of transactions in the invoice transaction history of the seller profile increase, a greater reliance is place on internal data on the transaction network as the quantity of transactions in the invoice transaction history of the seller profile increase.

At step 102B a seller internal projected Days Beyond Term (DBT) is determined based at least in part on the invoice transaction history associated with the seller.

The Seller's Internal Projected Days Beyond Term (IDBT_{S})—or the average days beyond term for internal transactions—is calculated similarly to both the Seller's Projected Invoice-Payment History Based Days Beyond Term (DBT_{SH}) and Internal Probability of Default (IPD_{S}), and is defined using:

Aₙ=Amount of the funding for invoice

IDBT_{Sn}=Aggregate timing (Days Beyond Term) of Seller's repayment of the invoice-funding for Invoice n, where “paid on time”=200, “paid x days late”=200−x (with 0 being the lowest permissible value), and “paid y days early”=200+y

The system then calculates the Seller's Internal Projected Days Beyond Term for the Seller's invoice-funding repayments (IDBT_{SH}) as follows:

IDBT_{S}=[(IDBT_{S1}*A₁)+(IDBT_{S2}*A₂)+ . . . +(IDBT_{SN}*A_{N})]/(A₁+A₂+ . . . +A_{N})

At step 103B a seller overall projected DBT is determined based at least in part on a plurality of seller-DBT variables and a plurality of dynamic seller-DBT weights associated with the plurality of seller-DBT variables. The plurality of seller-DBT variables include the seller internal projected DBT and one or more external DBT values associated with the seller.

The Seller Overall Projected Days Beyond Term (DBT) is calculated as:

DBT_{S}=f(AVERAGE(DBT_{SP},DBT_{SH}),IDBT_{S}) or more specifically:

DBT_{S}=(pᵢ*AVERAGE(DBT_{SP},DBT_{SH}))+(qᵢ+IDBT_{S})

As shown above, the plurality of seller-DBT variables include the seller internal projected DBT (IDBT) and one or more secondary DBT values associated with the seller. In this example, the one or more secondary DBT values include the Sellers Overall Paydex Score (DBT_{SP}) and the Seller's Projected Timing of Repayment (DBT_{SH}).

The overall DBT is also determined based upon a plurality of dynamic seller-DBT weights associated with the plurality of seller-DBT variables (pᵢ and qᵢ). The current values of the plurality of dynamic seller-DBT weights are determined based at least in part on real-time monitoring of transactions in the invoice transaction history of the seller profile

The coefficients pⱼ and qⱼ are regressed as a function of the number of repayment events over the past two years. Of course, other periods of time can be utilized. Until such a regression equation can be estimated, we will define:

pⱼ=0.3+[(0.7*MAX(20−j,0))/20] and

qⱼ=0.7*[MIN(20,j)/20]

For instance, if j=10 (that is, if 10 transactions have been completed in the past two years), then:

$$\begin{matrix}{p}_{j} = 0.3 + [ ( 0.7 * MAX ( 20 - 10 , 0 ) ) / 20 ] \\ = 0.3 + [ ( 0.7 * MAX ( 10 , 0 ) ) / 20 ] \\ = 0.3 + [ ( 0.7 * 10 ) / 20 ] \\ = 0.3 + [ 7 / 20 ] \\ = 0.3 + 0.35 \\ = 0.65\end{matrix}$$

$$\begin{matrix}{q}_{j} = 0.7 * [ MI N ( 20 , 10 ) / 20 ] \\ = 0.7 * [ 10 / 20 ] \\ = 0.7 * 0.5 \\ = 0.35\end{matrix}$$

As a result:

$$\begin{matrix}{p}_{j} + {q}_{j} = 0.65 + 0.35 \\ = 1.0\end{matrix}$$

As before, the various parameters assign greater weight to the internal, repayment-focused metric and lesser weight to the external metrics as the number of repayment events, j, grows larger.

The current values of the plurality of dynamic seller-DBT weights are determined based at least in part on real-time monitoring of transactions in the invoice transaction history of the seller profile. The plurality of dynamic seller-DBT weights include a first dynamic weight associated with the seller internal projected DBT and a second dynamic weight associated with the one or more external DBT values associated with the seller. A value of the first dynamic weight increases relative to a value of the second dynamic weight as the quantity of transactions in the invoice transaction history of the seller profile increase.

At step 102C a buyer internal probability of default is determined for a buyer party corresponding to the target invoice based at least in part on a portion of the invoice transaction history associated with both the seller and the buyer.

The Buyer's Internal Probability of Default (IPD) is calculated similarly to the Seller's corresponding metric, except that the Buyer's version has no Crowdz Probability of Default in it. The Buyer's Internal Probability of Default, IPDB, is given by:

IPD_{B}=[(A₁*IPS₁)+(A₂*IPS₂)+ . . . +(A_{N}*IPS_{N})]/[A₁+A₂+ . . . +A_{N}]

where:

Aᵢ=the amount of invoice i

IPSᵢ=the internal payment status for invoice i, that is, whether the invoice amount was paid (IPSᵢ=0) by the buyer or unpaid (IPSᵢ=1), as described above, within 90 days of its due date, for all invoice payments due over the previous two years. Of course, other periods of time can be utilized.

At step 103C a buyer overall probability of default is determined based at least in part on a plurality of buyer-default variables and a plurality of dynamic buyer-default weights associated with the plurality of buyer-default variables. The plurality of buyer-default variables including a buyer integrity score, one or more external probability of default scores associated with the buyer, and the buyer internal probability of default.

The probability of default is given by:

PD_{B}=CIS_{B}*PD_{BP}=CIS_{B}*f(AVERAGE(DBDS_{B},IPHDS_{B}),IPD_{B})

or more specifically:

PD_{B}=CIS_{B}*PD_{BP}=CIS_{B}*[(aⱼ*AVERAGE(DBDS_{B},IPHDS_{B}))+(bⱼ*IPD_{B})]

As shown above, the PD is based upon buyer-default variables and a plurality of dynamic buyer-default weights (aⱼ and bⱼ) associated with the plurality of buyer-default variables. The buyer-default variables include company integrity score (CIS), one or more secondary probability of default scores associated with the buyer (DBDS and IPHDS), and the buyer internal probability of default.

The coefficients aⱼ and bⱼ are regressed as a function of the number of payment events over the past two years. Of course, other periods of time can be utilized. Until such a regression equation can be estimated, we will define:

aⱼ=0.3+[(0.7*MAX(20−j,0))/20] and

bⱼ=0.7*[MIN(20,j)/20]

For instance, if j=10 (that is, if 10 transactions have been completed in the past two years), then:

$$\begin{matrix}{a}_{j} = 0.3 + [ ( 0.7 * MAX ( 20 - 10 , 0 ) ) / 20 ] \\ = 0.3 + [ ( 0.7 * MAX ( 10 , 0 ) ) / 20 ] \\ = 0.3 + [ ( 0.7 * 10 ) / 20 ] \\ = 0.3 + [ 7 / 20 ] \\ = 0.3 + 0.35 \\ = 0.65\end{matrix}$$

$$\begin{matrix}{b}_{j} = 0.7 * [ MI N ( 20 , 10 ) / 20 ] \\ = 0.7 * [ 10 / 20 ] \\ = 0.7 * 0.5 \\ = 0.35\end{matrix}$$

As a result:

$$\begin{matrix}{a}_{j} + {b}_{j} = 0.65 + 0.35 \\ = 1.0\end{matrix}$$

The parameters assign greater weight to the internal, payment-focused metric and lesser weight to the external metrics as the number of payment events, j, grows larger.

As shown above, the plurality of dynamic buyer-default weights include a first dynamic weight associated with the buyer internal probability of default and a second dynamic weight associated with the one or more secondary probability of default scores associated with the buyer and a value of the first dynamic weight increases relative to a value of the second dynamic weight as the quantity of transactions associated with the buyer and seller in the invoice transaction history of the seller profile increase.

Current values of the plurality of dynamic buyer-default weights are determined based at least in part on real-time monitoring of transactions associated with both the seller and the buyer in the invoice transaction history of the seller profile. The plurality of dynamic buyer-default weights include a first dynamic weight associated with the buyer internal probability of default and a second dynamic weight associated with the one or more external probability of default scores associated with the buyer. A value of the first dynamic weight increases relative to a value of the second dynamic weight as the quantity of transactions associated with the buyer and seller in the invoice transaction history of the seller profile increase.

At step 102D a buyer internal projected Days Beyond Term (DBT) is determined based at least in part on a portion of the invoice transaction history associated with both the buyer and the seller.

The Buyer's Internal Projected Days Beyond Term (IDBT_{S})—or the average days beyond term for internal is defined using:

Aₙ=Amount of the funding for invoice

IDBT_{Bn}=Aggregate timing (Days Beyond Term) of Buyer's payment of the invoice amount for Invoice n, where “paid on time”=200, “paid x days late”=200−x (with 0 being the lowest permissible value), and “paid y days early”=200+y

The system then calculates the Buyer's Internal Projected Days Beyond Term for the Buyer's invoice payment (IDBT_{BH}) as follows:

IDBT_{B}=[(IDBT_{B1}*A₁)+(IDBT_{B2}*A₂)+ . . . +(IDBT_{BN}*A_{N})]/(A₁+A₂+ . . . +A_{N})

At step 103D a buyer overall projected DBT is determined based at least in part on a plurality of buyer-DBT variables and a plurality of dynamic buyer-DBT weights associated with the plurality of buyer-DBT variables, the plurality of buyer-DBT variables comprising the buyer internal projected DBT and one or more external DBT values associated with the buyer.

The Buyer Overall Projected Days Beyond Term (DBT) is calculated as:

DBT_{B}=f(AVERAGE(DBT_{BP},DBT_{BH}),IDB_{TB}) or more specifically:

DBT_{B}=(pᵢ*AVERAGE(DBT_{BP},DBT_{BH}))+(qᵢ+IDBT_{B})

As shown above, the plurality of buyer-DBT variables include the buyer internal projected DBT (IDBT) and one or more secondary DBT values associated with the buyer. In this example, the one or more secondary DBT values include the Buyers Overall Paydex Score (DBT_{BP}) and the Buyer's Projected Timing of Repayment (DBT_{BH}).

The overall DBT is also determined based upon a plurality of dynamic buyer-DBT weights associated with the plurality of buyer-DBT variables (pᵢ and qᵢ). The current values of the plurality of dynamic buyer-DBT weights are determined based at least in part on real-time monitoring of transactions in the invoice transaction history of the buyer profile

The coefficients pⱼ and qⱼ are regressed as a function of the number of payment events over the past two years. Of course, other periods of time can be utilized. Until such a regression equation can be estimated, we will define:

pⱼ=0.3+[(0.7*MAX(20−j,0))/20] and

qⱼ=0.7*[MIN(20,j)/20]

For instance, if j=10 (that is, if 10 transactions have been completed in the past two years), then:

$$\begin{matrix}{p}_{j} = 0.3 + [ ( 0.7 * MAX ( 20 - 10 , 0 ) ) / 20 ] \\ = 0.3 + [ ( 0.7 * MAX ( 10 , 0 ) ) / 20 ] \\ = 0.3 + [ ( 0.7 * 10 ) / 20 ] \\ = 0.3 + [ 7 / 20 ] \\ = 0.3 + 0.35 \\ = 0.65\end{matrix}$$

$$\begin{matrix}{q}_{j} = 0.7 * [ MI N ( 20 , 10 ) / 20 ] \\ = 0.7 * [ 10 / 20 ] \\ = 0.7 * 0.5 \\ = 0.35\end{matrix}$$

As a result:

$$\begin{matrix}{p}_{j} + {q}_{j} = 0.65 + 0.35 \\ = 1.0\end{matrix}$$

As before, the various parameters assign greater weight to the internal, repayment-focused metric and lesser weight to the external metrics as the number of repayment events, j, grows larger.

Current values of the plurality of dynamic buyer-DBT weights are determined based at least in part on real-time monitoring of transactions in the invoice transaction history of the buyer profile. The plurality of dynamic buyer-DBT weights include a first dynamic weight associated with the buyer internal projected DBT and a second dynamic weight associated with the one or more external DBT values associated with the buyer. A value of the first dynamic weight increases relative to a value of the second dynamic weight as the quantity of transactions associated with the buyer and the seller in the invoice transaction history of the seller profile increase.

At step 104 a real-time risk score associated with a potential funder financing the target invoice is determined based at least in part on one or more of the seller overall probability of default, the seller overall projected DBT, the buyer overall probability of default, or the buyer overall projected DBT. In an exemplary embodiment, the real-time risk score associated with a potential funder financing the target invoice is determined based at least in part on all of these values (the seller overall probability of default, the seller overall projected DBT, the buyer overall probability of default, and the buyer overall projected DBT).

The real-time risk score, also referred to herein as the invoice pricing score, provides an overall Projected Funder Internal Rate of Return, IRRF, is such that the desired result IRRF=f (PPT, DPTT). The nature of the function f is defined below.

### 6.1 Combined Probabilities

In the above sections, we have calculated individual probabilities for the Seller and the Buyer. However, in order to generate a Projected Funder Internal Rate of Return, we need to know the combined probabilities. These are described below.

### 6.2 Known Variables

For a given invoice, there are a set of known variables as well as a set of projected variables.

The known variables are as follows:

Invoice value=V

Days until invoice is due=promised funding duration=x

Grace period for repaying funding, in days=g

LIBOR rate for x days=r(x)

Daily LIBOR (rD(x))=exp [ln (1+rD(x))/x]−1

### 6.3 Projected Variables

The projected variables are:

Probability that the Buyer pays the Seller for the invoice=PPB

Probability that the Seller repays the invoice-funding to the Funder, given the invoice is paid=PPS

Total probability that the Funder receives repayment for the invoice funding=PPT=PPB*PPS

Loss Given Default by the Seller (LGDS)

Exposure at Default by the Seller (EADS)

Expected Loss Ratio=ELRS=(1−PPT)*LGDS*EADS

Projected days after the invoice due date until the Buyer pays the Seller for the invoice=DBTB

Projected days after invoice payment until the Seller repays invoice-funding to Funder=DBTS

Total projected days beyond term until repayment is made=DBTT=DBTB+DBTS

Total projected days until funding is repaid (DURT) to the Funder=DURT=x+g+DBTT

Risk premium for promised funding duration=RPT=ELRS

Daily risk premium for promised funding duration=RPD=exp [ln (1+RPT)/x]−1

For convenience in what follows, we define DURT=y

### 6.4 Defining the Function

With this in mind, the function IRRF=f (PPT, DBTT) becomes:

IRRF=[1+(rD(x)+RPD)]y−1

Where this equation incorporates, by reference, all of the above known and projected values.

### 6.5 A Numerical Example

Assume that the known variables have the following values:

Invoice value=V=$10,000

Days until invoice is due=promised funding duration=x=90

Grace period for repaying funding, in days=g=5

LIBOR rate for x days=r(x)=0.02

Daily LIBOR (rD(x))=exp [ln (1+rD(x))/90]−1=exp [ln (1+0.02)/90]−1=0.0002201

Assume that the projected variables have the following values:

Probability that the Buyer pays the Seller for the invoice=PPB=99.00%

Probability Seller repays the invoice-funding to the Funder, given the invoice is paid=PPS=97.00%

Total probability Funder receives repayment for funding=PPT=PPB*PPS=0.99*0.97=96.03%

Loss Given Default by the Seller (LGDS)=0.40

Exposure at Default by the Seller (EADS)=100.00%

Expected Loss Ratio=ELRS=(1−0.9603)*0.40*1.00=0.0397*0.40*1.00=0.01588

Projected days after the invoice due date until the Buyer pays the Seller for the invoice=DBTB=60

Projected days after invoice payment until the Seller repays invoice-funding to Funder=DBTS=25

Total projected days beyond term until repayment is made=DBTT=60+25=85

Total projected days until funding is repaid to Funder=DURT=x+g+DBTT=90+5+85

Risk premium for promised funding duration=RPT=ELRS=0.01588=1.588%

Daily risk premium=RPD=exp [ln (1+RPT)/x]−1=exp [ln (1+0.01588)/90]−1=0.0001751

The calculation then becomes:

$$\begin{matrix}Projected Funder IRR ( IRRF ) = [ 1 + ( r D + R P D ) ] y - 1 \\ = [ 1 + ( 0.0002201 + 0.0001751 ) ] 180 - 1 \\ = [ 1 + 0.0003952 ] 180 - 1 \\ = [ 1.000 \; 3952 ] 180 - 1 \\ = 1.0739606 - 1 \\ = 0.0737 \; 122 \\ = 7.37 \%\end{matrix}$$

As noted, the Projected Funder Return is determined based on projected time until repayment

In this case, the value (VO) of the Funder's invoice offer would be as follows:

$$\begin{matrix}VO = V * ( 1 - IRRF ) \\ = \$10 , 000.00 * ( 1 - 0.0739606 ) \\ = \$10 , 000.00 * 0.9260394 \\ = \$9 , 260.39\end{matrix}$$

The IRRF metric has an equivalent as the Required Discount for Funding (RDF). The correlation between the two is as follows:

In order for an investment to be financially worthwhile, an investor (e.g., a Funder of invoices) requires a return that, at a minimum, exceeds the combination of the cost of money (i.e., the LIBOR rate) and the risk premium (the expected loss) over the projected length of time the money is invested and hence unavailable for other uses by the Funder (the projected funding period). Those two figures combine to create the Required Discount, or the percentage off the invoice premium that the Funder must receive in order to make the funding of a particular invoices financially worthwhile.

For instance, in the example just provided, the combination of the cost of money and the risk premium over the projected length of the funding period is 7.37%. That is, the Funder must receive a discount of at least this amount in order to make the Funding financially worthwhile, based on expectations. Should the Funder purchase the invoice at just this discount, the Funder would receive an IRR of 7.37% over the projected funding period. If the funding is repaid earlier, the IRR will increase, and if the funding is repaid later, the funding will decrease.

So if Invoice A has a required discount of 10% (thus offering the expectation of a 10% return) and Invoice B has a required discount of 20% (thus offering the expectation of a 20% return), is Invoice B (with the higher expected return) a better investment? Not necessarily. In fact, the opposite may be the case. Expectations are not guaranteed, and riskier investments (i.e., those with a higher required discount) are likely to have a higher downside, and hence to return less than promised. In addition, in the case of Invoice A, the Funder need secure only a 10% IRR in order to break even, or make money greater than the expected amount of the gain, whereas, for Invoice B, the Funder needs to secure an IRR of twice as great—20%—a much greater challenge.

Therefore, the IRR is not the promised (or even expected) return on the invoice in the abstract, but only if the invoice is purchased at that discount rate. To use the above example, if a Funder buys Invoice A, with its nominal 10% IRR but accepts a discount of 20%, while the Funder still might wind up making money, the expectation is that the Funder will actually lose 10% (10% IRR less the 20% return), certainly not a profitable investment.

Annualized IRRs. The IRRs for separate invoice purchases are not necessarily comparable. For instance, if Invoice C is expected to return 10% in 180 days and Invoice D is expected to return 5% in 60 days, Invoice C is not the better investment.

The Funder of Invoice C would be able to make two invoice purchases of the type described within a one-year period (since there are approximately two 180-day periods in a year), for a total return of approximately 20% (2×10%). But the Funder of Invoice D would be able to make six invoice purchases within a year (since there are approximately six 60-day periods in a year), for a total return of 30% (6×5%). In short, invoices with dissimilar expected funding periods cannot be compared straight across.

Instead, the IRRs must be annualized. Above, we used this equation to calculate the IRR on the illustrative invoice purchase:

$$\begin{matrix}Projected Funder IRR ( IRRF ) = [ 1 + ( r D + R P D ) ] y - 1 \\ = [ 1 + ( 0.0002201 + 0.0001751 ) ] 180 - 1 \\ = [ 1 + 0.0003952 ] 180 - 1 \\ = [ 1.000 \; 3952 ] 180 - 1 \\ = 1.0739606 - 1 \\ = 0.0737 \; 122 \\ = 7.37 \%\end{matrix}$$

To calculate the annualized IRR, we substitute y=365 for y=180 in the above equation. This yields the following:

$$\begin{matrix}Projected Funder IRR ( IRRF ) = [ 1 + ( r D + R P D ) ] y - 1 \\ = [ 1 + ( 0.0002201 + 0.0001751 ) ] 365 - 1 \\ = [ 1 + 0.0003952 ] 365 - 1 \\ = [ 1.000 \; 3952 ] 365 - 1 \\ = 1.1551376 - 1 \\ = 0.1551376 \\ = 15.51 \%\end{matrix}$$

(Note that the latter IRR is more than twice the value of the former not only because 365 is more than twice the value of 180, but also because of the effect of daily compounding.)

By using annualized compounding of daily rates, the relative expected worth of invoice purchases of different amounts, different discounts, and different expected funding periods can be readily compared. (Of course, this is a purely mathematical comparison: different Funders have different risk appetites or risk tolerances, different amounts of money available with which to purchase invoices, and so on, and these subjective factors will affect different Funders' evaluation of the same prospective invoice purchase with a given objective expected return.)

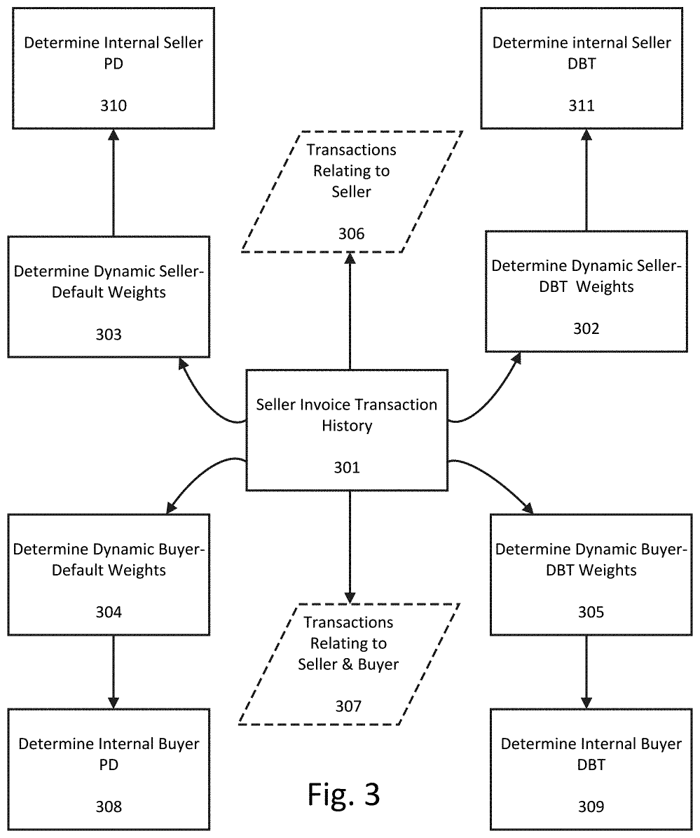

As explained above, the present system utilizes real-time monitoring of invoice transaction history of a seller and also the transaction history of seller with a particular buyer. FIG. 3 illustrates the use of seller invoice transaction history for determination of dynamic weights according to an exemplary embodiment.

As shown in FIG. 3, transaction relating to a seller 306 are extracted/filter/monitored from the seller invoice transaction history 301 and used to determine dynamic seller-default weights 303 and determine dynamic seller-DBT weights 302. These, in turn are used to determine the internal seller probability of default 310 and determine the internal seller projected days beyond term 311.

Similarly, transactions relating to a seller and buyer 307 are extracted/filter/monitored from the seller invoice transaction history 301 and used to determine dynamic buyer-default weights 304 and determine dynamic buyer-DBT weights 305. These are then used to determine internal buyer probability of default 308 and to determine internal buyer projected days beyond term 309.

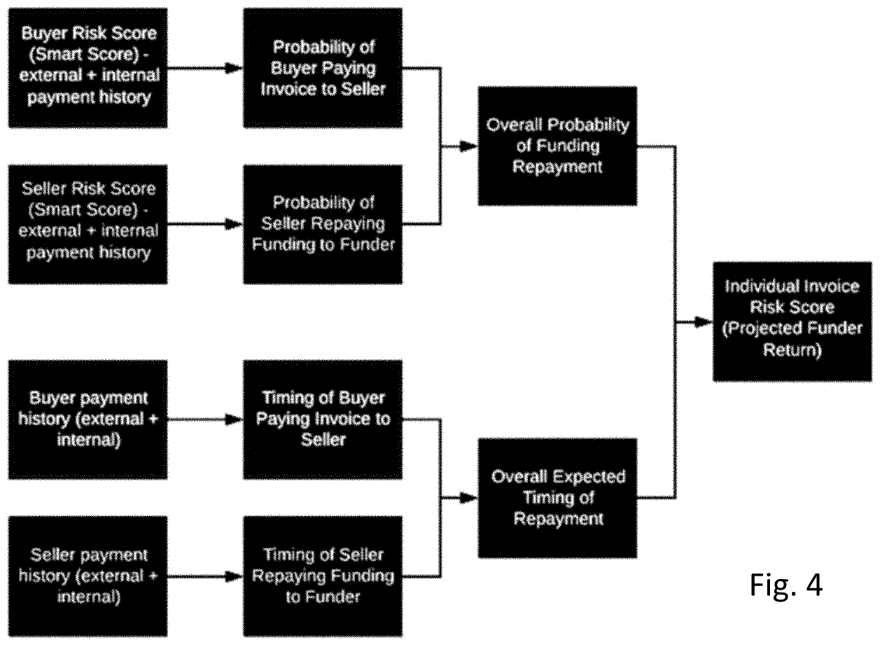

FIGS. 4-9C illustrate additional aspects of the present system according to an exemplary embodiment. FIG. 4 illustrates a flowchart for generating an invoice risk score (projected funder return) according to an exemplary embodiment.

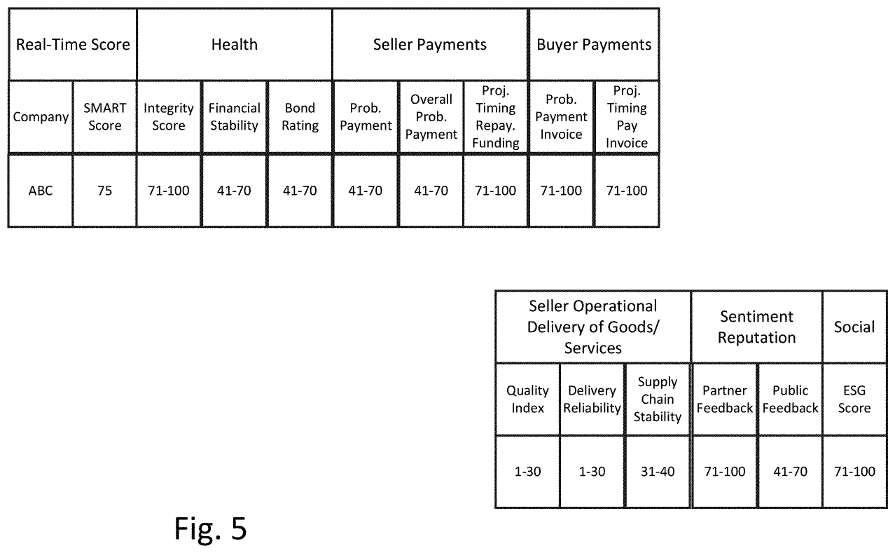

FIG. 5 illustrates an example of a real-time risk score for a company, including different components of the score, according to an exemplary embodiment.

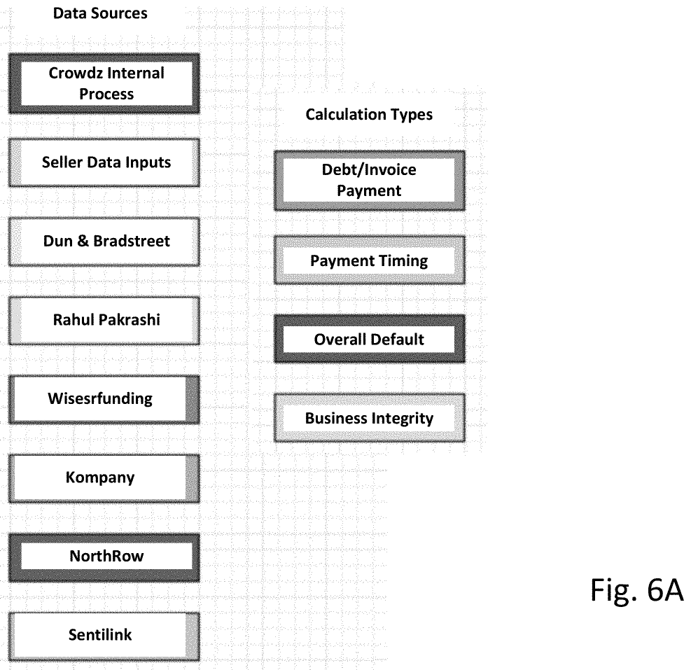

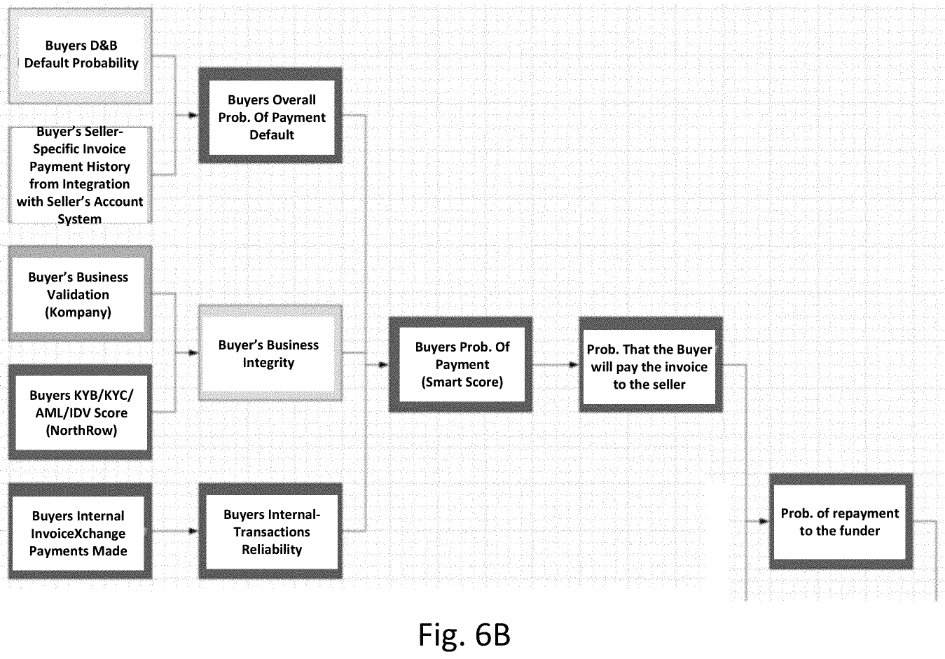

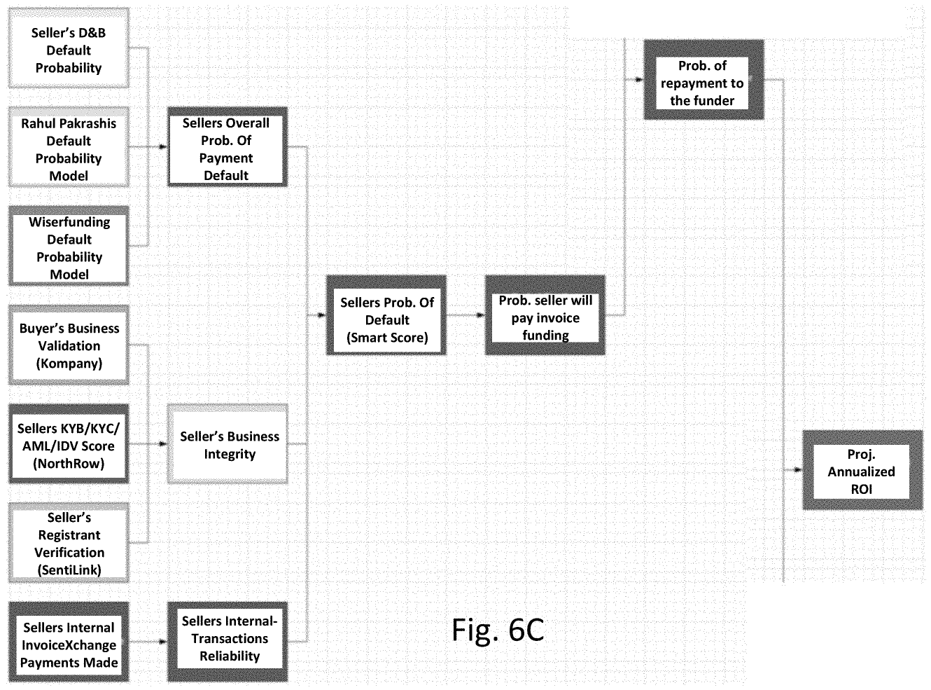

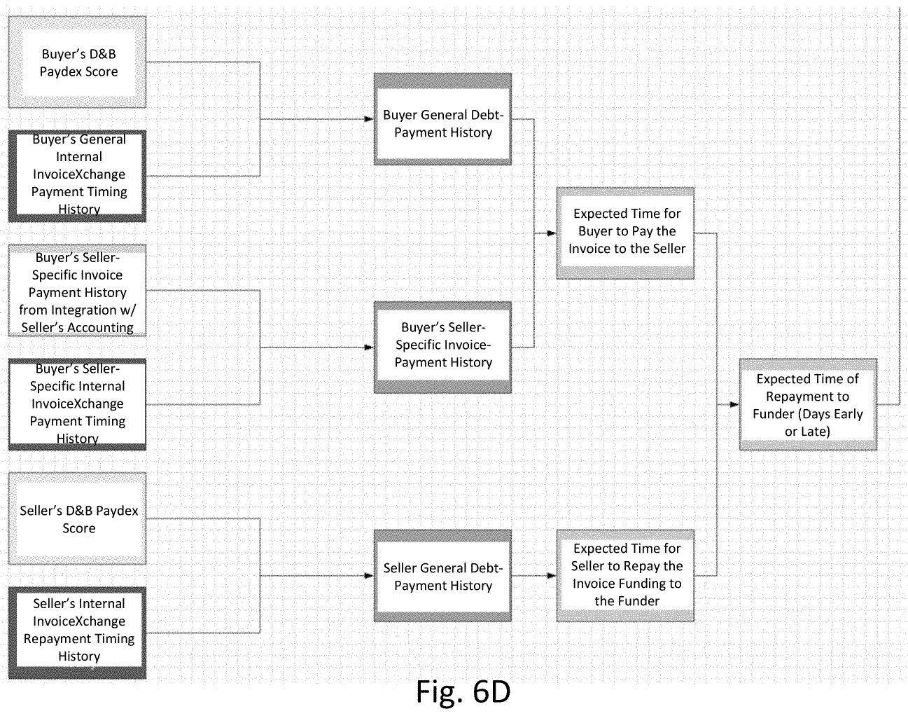

FIGS. 6A-6D illustrate the inputs to the various metrics and scores utilized by the present system in generating the projected annualized ROI and a flowchart for generating the projected annualized ROI according to an exemplary embodiment. FIG. 6A is a key and the steps shown in FIGS. 6B-6D all flow to the step of determining the projected annualized ROI (shown in FIG. 6C).

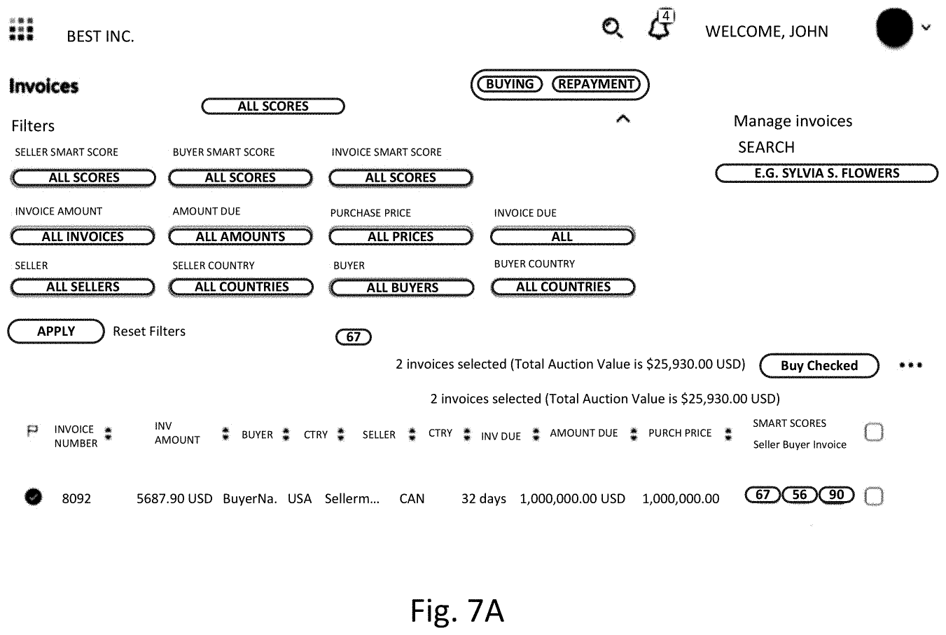

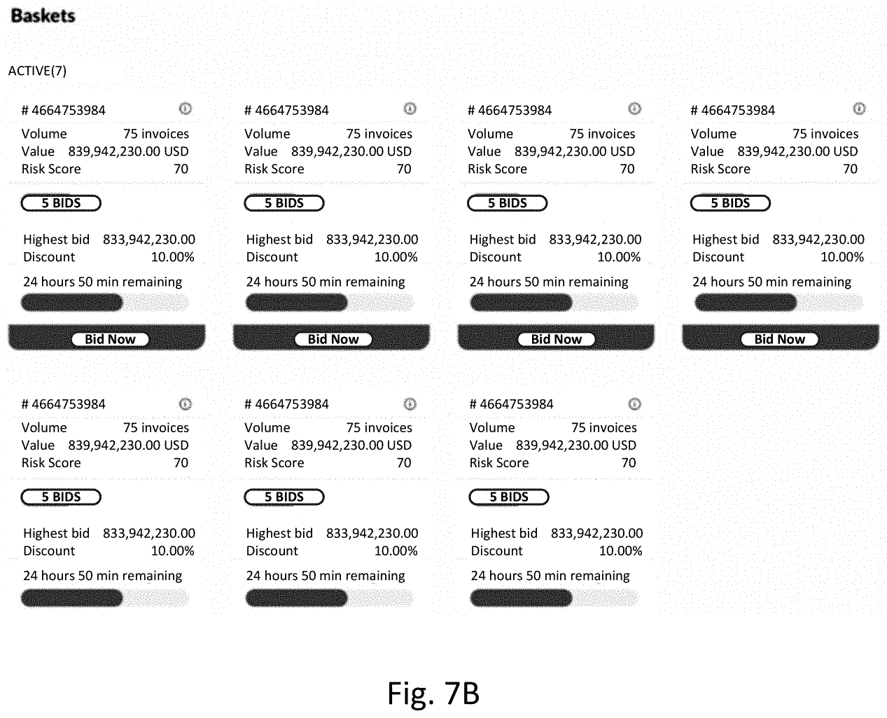

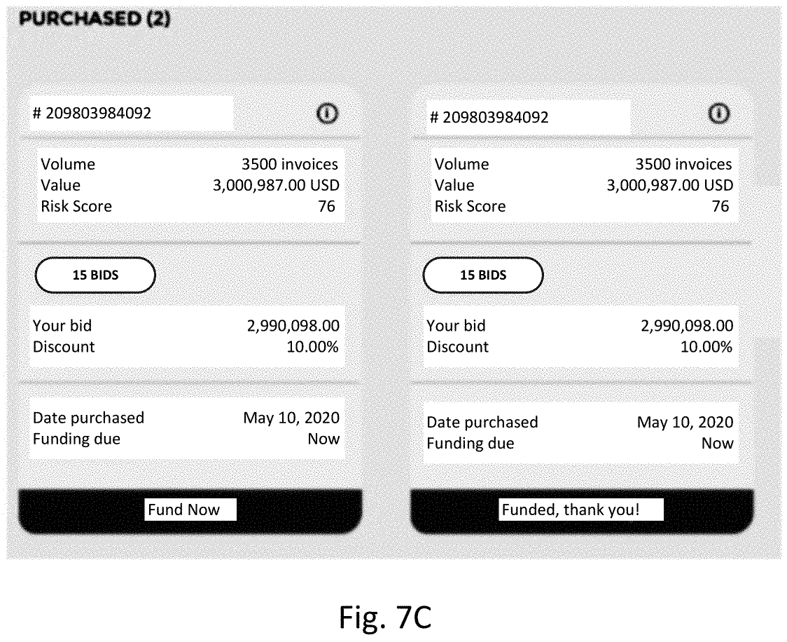

FIGS. 7A-7C illustrate interfaces for viewing invoices and baskets of invoices and bidding on invoices, along with scores corresponding to buyers, sellers, and overall risk, according to an exemplary embodiment.

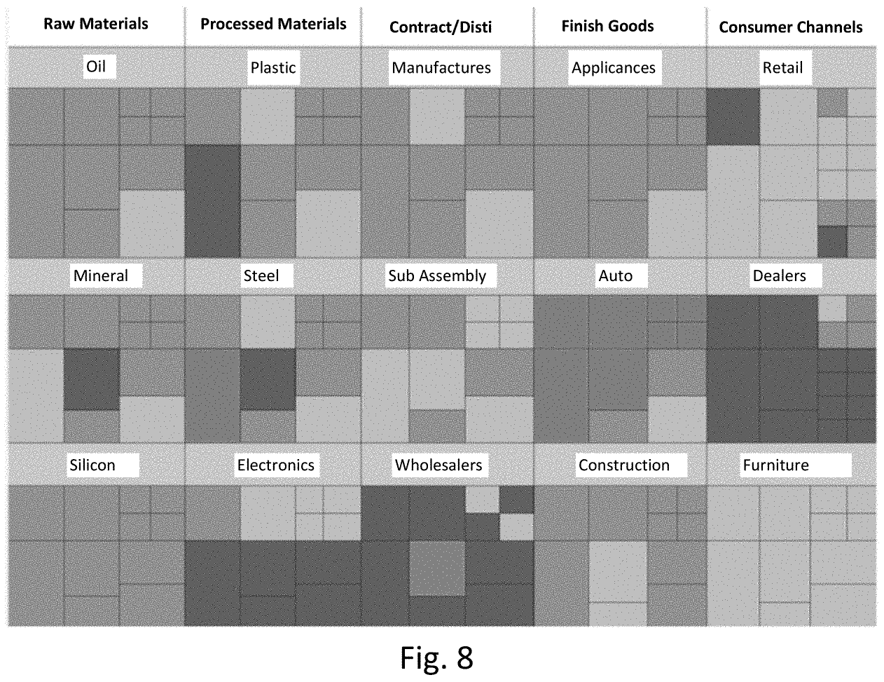

FIG. 8 illustrates heats maps of the supply chain, industry, or location that summarizes all of the risk scores in a view that allows users see real-time risk per segment according to an exemplary embodiment.

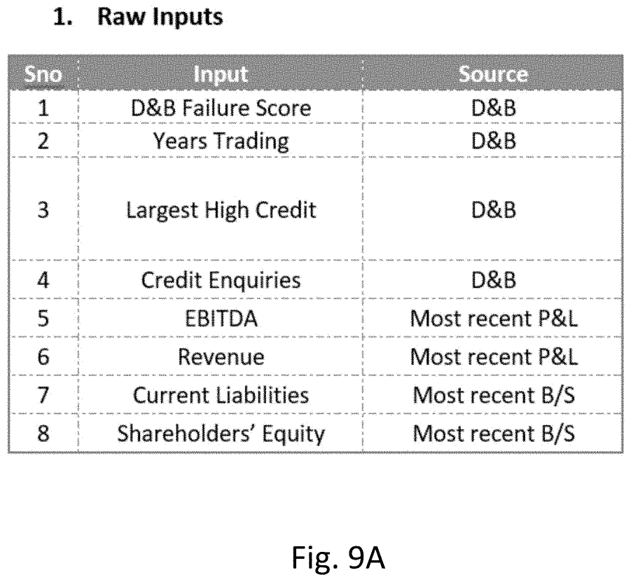

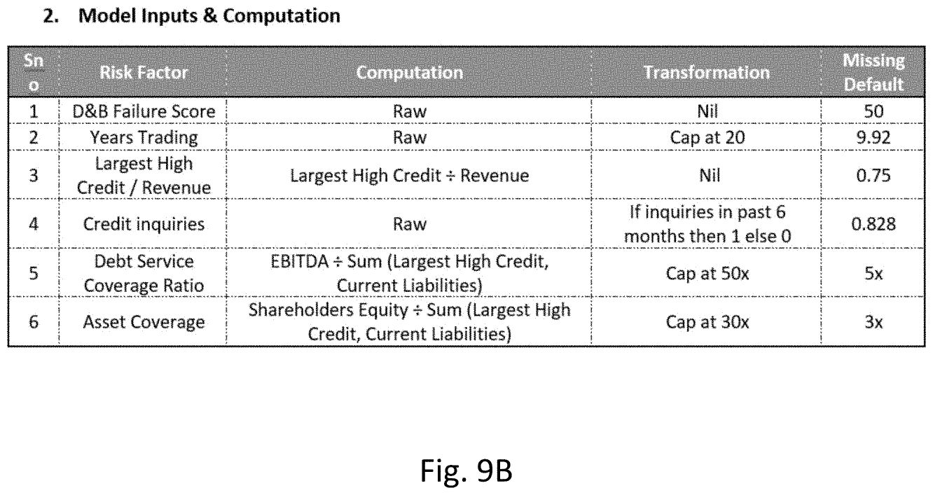

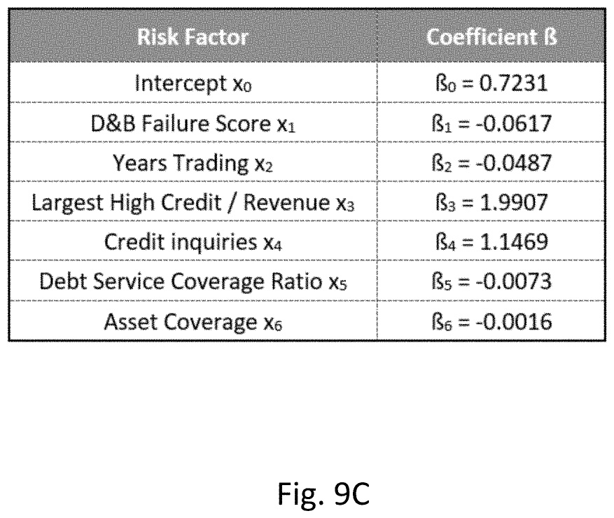

FIGS. 9A-9C illustrate tables with raw inputs, model inputs & computation, and risk factors according to an exemplary embodiment. FIG. 9C illustrates risk scores:

Risk Score [RS]=Σ(ßᵢxᵢ) where:

xᵢ is the ith risk factor. x₁=D&B Failure Score, x₂=years trading, x₃=Largest high credit/revenue, x₄=credit inquiries, x₅=debt service coverage ratio, x₆=Asset Coverage

ßᵢ is the coefficient for xᵢ

RS=Σ(ßᵢxᵢ)

The probability of default can then be given as PD=1÷(1+exp(−Σ(ßx))

Sample:

PD=1/(1+exp(−(0.7231+(−0.0617*75)+(−0.0487*10)+(1.9907*(25000/500,000))+(1.1469*3)+(−0.0073/1.2)+(−0.0016*0.8))))

The smart score can then be given as SS=1−PD

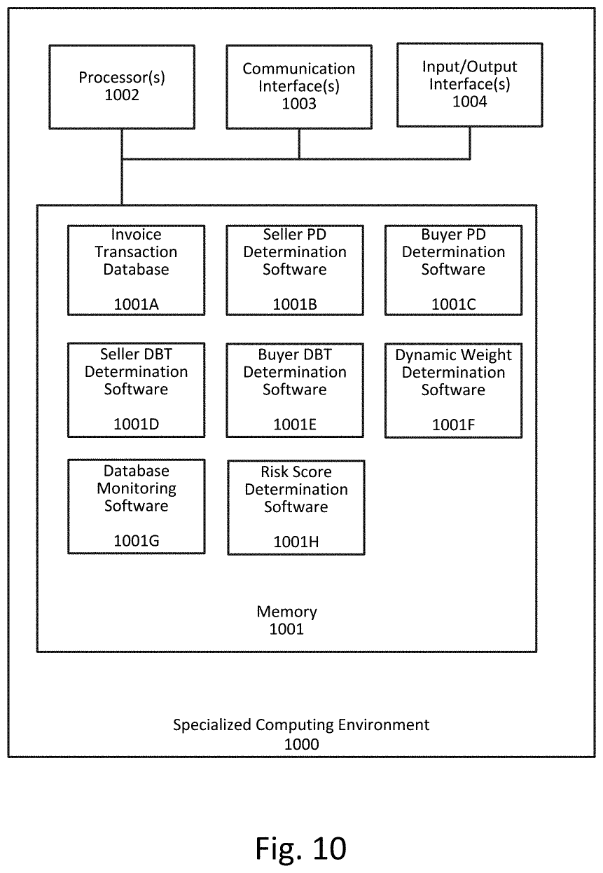

FIG. 10 illustrates the components of the specialized computing environment 1000 configured to perform the specialized processes described herein. Specialized computing environment 1000 is a computing device that includes a memory 1001 that is a non-transitory computer-readable medium and can be volatile memory (e.g., registers, cache, RAM), non-volatile memory (e.g., ROM, EEPROM, flash memory, etc.), or some combination of the two.

As shown in FIG. 10, memory 1001 can include invoice transaction database 1001A, seller PD determination software 1001B, buyer PD determination software 1001C, seller DBT determination software 1001D, buyer DBT determination software 1001E, dynamic weight determination software 1001F, database monitoring software 1001G, risk score determination software 1001H. Each of the software components in memory 1001 store specialized instructions and data structures configured to perform the corresponding functionality and techniques described herein.

All of the software stored within memory 1001 can be stored as a computer-readable instructions, that when executed by one or more processors 1002, cause the processors to perform the functionality described with respect to FIGS. 1-9.

Processor(s) 1002 execute computer-executable instructions and can be a real or virtual processors. In a multi-processing system, multiple processors or multicore processors can be used to execute computer-executable instructions to increase processing power and/or to execute certain software in parallel.

Specialized computing environment 1000 additionally includes a communication interface 1003, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 1000 further includes input and output interfaces 1004 that allow users (such as system administrators) to provide input to the system to set parameters, to edit data stored in memory 1001, or to perform other administrative functions.

An interconnection mechanism (shown as a solid line in FIG. 10), such as a bus, controller, or network interconnects the components of the specialized computing environment 1000.

Input and output interfaces 1004 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 1000.

Specialized computing environment 1000 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 1000.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Elements of the described embodiment shown in software may be implemented in hardware and vice versa.

It will be appreciated by those skilled in the art that changes could be made to the embodiments described above without departing from the broad inventive concept thereof. For example, the steps or order of operation of one of the above-described methods could be rearranged or occur in a different series, as understood by those skilled in the art. It is understood, therefore, that this disclosure is not limited to the particular embodiments disclosed, but it is intended to cover modifications within the spirit and scope of the present disclosure.

1. A method executed by one or more computing devices for generating a real-time risk score associated with financing of an invoice based on real-time transaction data, the method comprising:
storing a seller profile corresponding to a seller that issues invoices, the seller profile comprising an invoice transaction history, each invoice in the invoice transaction history being associated with a buyer responsible for payment of the invoice;
determining a seller internal probability of default corresponding to a target invoice issued by the seller based at least in part on the invoice transaction history associated with the seller;
determining a seller overall probability of default based at least in part on a plurality of seller-default variables and a plurality of dynamic seller-default weights associated with the plurality of seller-default variables, the plurality of seller-default variables comprising a seller integrity score, one or more secondary probability of default scores associated with the seller, and the seller internal probability of default, wherein current values of the plurality of dynamic seller-default weights are determined based at least in part on real-time monitoring of transactions in the invoice transaction history of the seller profile; and
generating a real-time risk score associated with a potential funder financing the target invoice based at least in part on the seller overall probability of default.

2. The method of claim 1, wherein the plurality of dynamic seller-default weights comprise a first dynamic weight associated with the seller internal probability of default and a second dynamic weight associated with the one or more secondary probability of default scores and wherein a value of the first dynamic weight increases relative to a value of the second dynamic weight as the quantity of transactions in the invoice transaction history of the seller profile increase.

3. The method of claim 1, wherein each invoice in the invoice transaction history is further associated with a funder that provided financing to the seller party through collateralization of the invoice and wherein the seller internal probability of default is further determined based at least in part on a portion of the invoice transaction history associated with both the seller and the potential funder.

4. The method of claim 1, further comprising:
determining a seller internal projected Days Beyond Term (DBT) based at least in part on the invoice transaction history associated with the seller; and
determining a seller overall projected DBT based at least in part on a plurality of seller-DBT variables and a plurality of dynamic seller-DBT weights associated with the plurality of seller-DBT variables, the plurality of seller-DBT variables comprising the seller internal projected DBT and one or more secondary DBT values associated with the seller, wherein current values of the plurality of dynamic seller-DBT weights are determined based at least in part on real-time monitoring of transactions in the invoice transaction history of the seller profile;
wherein the real-time risk score associated with the potential funder financing the target invoice is further determined based at least in part on the seller overall projected DBT.

5. The method of claim 1, wherein the plurality of dynamic seller-DBT weights comprise a first dynamic weight associated with the seller internal projected DBT and a second dynamic weight associated with the one or more secondary DBT values associated with the seller and wherein a value of the first dynamic weight increases relative to a value of the second dynamic weight as the quantity of transactions in the invoice transaction history of the seller profile increase.

6. The method of claim 1, further comprising:
determining a buyer internal probability of default for a buyer party corresponding to the target invoice based at least in part on a portion of the invoice transaction history associated with both the seller and the buyer; and
determining a buyer overall probability of default based at least in part on a plurality of buyer-default variables and a plurality of dynamic buyer-default weights associated with the plurality of buyer-default variables, the plurality of buyer-default variables comprising a buyer integrity score, one or more secondary probability of default scores associated with the buyer, and the buyer internal probability of default, wherein current values of the plurality of dynamic buyer-default weights are determined based at least in part on real-time monitoring of transactions associated with both the seller and the buyer in the invoice transaction history of the seller profile;
wherein the real-time risk score associated with the potential funder financing the target invoice is further determined based at least in part on the buyer overall probability of default.

7. The method of claim 1, wherein the plurality of dynamic buyer-default weights comprise a first dynamic weight associated with the buyer internal probability of default and a second dynamic weight associated with the one or more secondary probability of default scores associated with the buyer and wherein a value of the first dynamic weight increases relative to a value of the second dynamic weight as the quantity of transactions associated with the buyer and seller in the invoice transaction history of the seller profile increase.

8. The method of claim 1, further comprising:
determining a buyer internal projected Days Beyond Term (DBT) based at least in part on a portion of the invoice transaction history associated with both the buyer and the seller; and
determining a buyer overall projected DBT based at least in part on a plurality of buyer-DBT variables and a plurality of dynamic buyer-DBT weights associated with the plurality of buyer-DBT variables, the plurality of buyer-DBT variables comprising the buyer internal projected DBT and one or more secondary DBT values associated with the buyer, wherein current values of the plurality of dynamic buyer-DBT weights are determined based at least in part on real-time monitoring of transactions in the invoice transaction history of the buyer profile;
wherein the real-time risk score associated with the potential funder financing the target invoice is further determined based at least in part on the buyer overall projected DBT.

9. The method of claim 1, wherein the plurality of dynamic buyer-DBT weights comprise a first dynamic weight associated with the buyer internal projected DBT and a second dynamic weight associated with the one or more secondary DBT values associated with the buyer and wherein a value of the first dynamic weight increases relative to a value of the second dynamic weight as the quantity of transactions associated with the buyer and the seller in the invoice transaction history of the seller profile increase.

10. An apparatus for generating a real-time risk score associated with financing of an invoice based on real-time transaction data, the apparatus comprising:
one or more processors; and
one or more memories operatively coupled to at least one of the one or more processors and having instructions stored thereon that, when executed by at least one of the one or more processors, cause at least one of the one or more processors to:
store a seller profile corresponding to a seller that issues invoices, the seller profile comprising an invoice transaction history, each invoice in the invoice transaction history being associated with a buyer responsible for payment of the invoice;
determine a seller internal probability of default corresponding to a target invoice issued by the seller based at least in part on the invoice transaction history associated with the seller;
determine a seller overall probability of default based at least in part on a plurality of seller-default variables and a plurality of dynamic seller-default weights associated with the plurality of seller-default variables, the plurality of seller-default variables comprising a seller integrity score, one or more secondary probability of default scores associated with the seller, and the seller internal probability of default, wherein current values of the plurality of dynamic seller-default weights are determined based at least in part on real-time monitoring of transactions in the invoice transaction history of the seller profile; and
generate a real-time risk score associated with a potential funder financing the target invoice based at least in part on the seller overall probability of default.

11. The apparatus of claim 10, wherein the plurality of dynamic seller-default weights comprise a first dynamic weight associated with the seller internal probability of default and a second dynamic weight associated with the one or more secondary probability of default scores and wherein a value of the first dynamic weight increases relative to a value of the second dynamic weight as the quantity of transactions in the invoice transaction history of the seller profile increase.

12. The apparatus of claim 10, wherein each invoice in the invoice transaction history is further associated with a funder that provided financing to the seller party through collateralization of the invoice and wherein the seller internal probability of default is further determined based at least in part on a portion of the invoice transaction history associated with both the seller and the potential funder.

13. The apparatus of claim 10, wherein the plurality of dynamic seller-DBT weights comprise a first dynamic weight associated with the seller internal projected DBT and a second dynamic weight associated with the one or more secondary DBT values associated with the seller and wherein a value of the first dynamic weight increases relative to a value of the second dynamic weight as the quantity of transactions in the invoice transaction history of the seller profile increase.

14. The apparatus of claim 10, wherein the plurality of dynamic seller-DBT weights comprise a first dynamic weight associated with the seller internal projected DBT and a second dynamic weight associated with the one or more secondary DBT values associated with the seller and wherein a value of the first dynamic weight increases relative to a value of the second dynamic weight as the quantity of transactions in the invoice transaction history of the seller profile increase.

15. At least one non-transitory computer-readable medium storing computer-readable instructions that, when executed by one or more computing devices, cause at least one of the one or more computing devices to:
store a seller profile corresponding to a seller that issues invoices, the seller profile comprising an invoice transaction history, each invoice in the invoice transaction history being associated with a buyer responsible for payment of the invoice;
determine a seller internal probability of default corresponding to a target invoice issued by the seller based at least in part on the invoice transaction history associated with the seller;
determine a seller overall probability of default based at least in part on a plurality of seller-default variables and a plurality of dynamic seller-default weights associated with the plurality of seller-default variables, the plurality of seller-default variables comprising a seller integrity score, one or more secondary probability of default scores associated with the seller, and the seller internal probability of default, wherein current values of the plurality of dynamic seller-default weights are determined based at least in part on real-time monitoring of transactions in the invoice transaction history of the seller profile; and
generate a real-time risk score associated with a potential funder financing the target invoice based at least in part on the seller overall probability of default.

16. The at least one non-transitory computer-readable medium of claim 15, wherein the plurality of dynamic seller-default weights comprise a first dynamic weight associated with the seller internal probability of default and a second dynamic weight associated with the one or more secondary probability of default scores and wherein a value of the first dynamic weight increases relative to a value of the second dynamic weight as the quantity of transactions in the invoice transaction history of the seller profile increase.

17. The at least one non-transitory computer-readable medium of claim 15, wherein each invoice in the invoice transaction history is further associated with a funder that provided financing to the seller party through collateralization of the invoice and wherein the seller internal probability of default is further determined based at least in part on a portion of the invoice transaction history associated with both the seller and the potential funder.

18. The at least one non-transitory computer-readable medium of claim 15, wherein the plurality of dynamic seller-DBT weights comprise a first dynamic weight associated with the seller internal projected DBT and a second dynamic weight associated with the one or more secondary DBT values associated with the seller and wherein a value of the first dynamic weight increases relative to a value of the second dynamic weight as the quantity of transactions in the invoice transaction history of the seller profile increase.

19. The at least one non-transitory computer-readable medium of claim 15, wherein the plurality of dynamic seller-DBT weights comprise a first dynamic weight associated with the seller internal projected DBT and a second dynamic weight associated with the one or more secondary DBT values associated with the seller and wherein a value of the first dynamic weight increases relative to a value of the second dynamic weight as the quantity of transactions in the invoice transaction history of the seller profile increase.
